(19) United States
(12) Patent Application Publication
(10) Pub. No.: US 2021/0168673 A1
(43) Pub. Date: Jun. 3, 2021

(54) Information Encoding and Message Transmission at Secondary Cell Group Failure

(71) Applicant: Telefonaktiebolaget LM Ericsson (publ), Stockholm (SE)

(72) Inventors: Rui Fan, Beijing (CN); Icaro L. J. da Silva, Solna (SE); Oumer Teyeb, Solna (SE)

(21) Appl. No.: 16/061,871

(22) PCT Filed: May 3, 2018
(86) PCT No.: PCT/SE2018/050451

§ 371 Date: Jun. 13, 2018

(30) Foreign Application Priority Data
Jun. 16, 2017 (CN) PCT/CN2017/088798

(51) Int. Cl. H04W 36/00; H04W 76/15; H04W 76/18

(52) U.S. Cl. CPC H04W 36/0069; H04W 76/18; H04W 76/15

(57) ABSTRACT

Embodiments of the present disclosure provide methods, apparatuses and computer program for a method handling radio connectivity failure wherein the wireless device is connected to a radio first network node through a first radio connection and to at least a second radio network node through at least a second radio connection using Dual Connectivity, comprising: receiving from the first network node a first measurement configuration for measuring radio related characteristics for the first radio connection, receiving from the second network node a second measurement configuration for measuring radio related characteristics for the at least second radio connection, detecting a radio connectivity failure for the at least one second radio connection, and transmitting a message to the first radio network node using the first radio connection wherein the message comprises measurement results according to the received measurement configuration for the second radio connection.

### TECHNICAL FIELD

The non-limiting and example embodiments of the present disclosure generally relate to a technical field of wireless communication, and specifically to methods, apparatuses and computer programs for information encoding and message transmission at Secondary Cell Group failure in a wireless communication system.

### BACKGROUND

This section introduces aspects that may facilitate a better understanding of the disclosure. Accordingly, the statements of this section are to be read in this light and are not to be understood as admissions about what is in the prior art or what is not in the prior art.

Currently a new fifth generation(5G) radio access technique (RAT) called New Radio (NR) is being studied in the third generation partnership project (3GPP) aiming at providing enhanced mobile broadband (eMBB) communication, massive machine type (MTC) communications, and ultra-reliable and low latency communications (URLLC). It has been agreed in 3GPP to define a new Next Generation Core network (NG CN, also referred to as 5G CN) to support the NR. In addition, a tight interworking between the fourth generation (4G) Long Term Evolution (LTE) and the 5G NR is desired.

The introduction of new RAT and new CN brings challenges to mobility of terminal devices.

### SUMMARY

The introduction of new RAT and new CN brings challenges to connectivity of terminal devices. In order to solve at least part of problems existing in conventional solutions for connectivity of terminal devices, methods, apparatuses and computer programs are provided in the present disclosure. It can be appreciated that embodiments of the present disclosure are not limited to a NR wireless communication system, but could be more widely applied to any application scenario where similar problems exist.

Various embodiments of the present disclosure mainly aim at providing methods, apparatuses and computer programs for Information encoding and message transmission at Secondary Cell group failure in a wireless communication system. Other features and advantages of embodiments of the present disclosure will also be understood from the following description of specific embodiments when read in conjunction with the accompanying drawings, which illustrate, by way of example, the principles of embodiments of the present disclosure.

In a first aspect of the disclosure, there is provided a method implemented in a wireless device for handling radio connectivity failure wherein the wireless device is connected to a first radio network node through a first radio connection and to at least a second radio network node through at least a second radio connection using Dual Connectivity. The method comprises receiving from the first network node a first measurement configuration for measuring radio related characteristics for the first radio connection, receiving from the second network node a second measurement configuration for measuring radio related characteristics for the at least second radio connection, detecting a radio connectivity failure for the at least one second radio connection, and transmitting a message to the first radio network node using the first radio connection wherein the message comprises measurement results according to the received measurement configuration for the second radio connection.

According to one embodiment the first radio network node is an LTE radio network node and the second radio network node is an NR radio network node.

According to a further embodiment the wireless device is configured with a first RRC protocol for the first radio connection and a second RRC protocol for the at least second radio connection and wherein the first and second RRC protocols are different RRC protocols.

According to a further embodiment the first and second measurement configurations define different measurements.

According to a further embodiment the second RRC protocol implements at least one type of radio measurements which is not implemented by the first RRC protocol,

According to a further embodiment the first RRC protocol is unable to decode at least one radio measurement result obtained through configuration by the second RRC protocol.

According to a further embodiment the first radio connection is a primary cell group and the second radio connection is a secondary cell group and wherein the first radio network node is a Master Node and the second radio network node is a Secondary Node and wherein the failure report is a Secondary Cell Group failure message.

According to a further embodiment the method further comprising encoding an SCG failure report according to the specification of the second RRC protocol, wherein the SCG failure report includes measurement results based on the received measurement configuration for the second radio connection, encapsulating the SCG failure report in said message and wherein said message is encoded according to the first RRC protocol.

According to a further embodiment the encapsulation is achieved using an octet string of data and wherein said message is an SCG failure message encoded according to the first RRC protocol.

According to a further embodiment said message comprises measurement results based on the received measurement configuration for the first radio connection.

In a second aspect of the disclosure, there is provided a method implemented in a radio network node for handling Secondary Cell Group failure, comprising transmitting a measurement configuration to a User Equipment, receiving a SCG failure message from said User Equipment, decoding said SCG failure message, identifying an encapsulated message in said SCG failure message, and transmitting said encapsulated message to a second radio network node.

According to a further embodiment the method further comprising obtaining the address of the second radio network node from the SCG failure message

In a third aspect of the disclosure, there is provided a wireless device comprising a processor and a memory, wherein said memory comprises instructions executable by said processor whereby said wireless device is operable to perform any of the methods suitable for implementation in a wireless device.

In a third aspect of the disclosure, there is provided a radio network node comprising a processor and a memory, wherein said memory comprises instructions executable by said processor whereby said radio network node is operable to perform any of the methods suitable for implementation in a radio network node.

In a third aspect of the disclosure, there is provided a computer program product, comprising instruction which, when executed on a processor cause the processor to carry out any of the methods suitable for implementation in a wireless device.

In a fourth aspect of the disclosure, there is provided a wireless device for handling radio connectivity failure wherein the wireless device is connected to a radio first network node through a first radio connection and to at least a second radio network node through at least a second radio connection using Dual Connectivity, comprising a receiving unit configured to receive from the first network node a first measurement configuration for measuring radio related characteristics for the first radio connection, and receiving from the second network node a second measurement configuration for measuring radio related characteristics for the at least second radio connection, a detecting unit provided to detect a radio connectivity failure for the at least one second radio connection, and a transmitting unit configured to transmit a message to the first radio network node using the first radio connection wherein the message comprises measurement results according to the received measurement configuration for the second radio connection.

In a fifth aspect of the disclosure, there is provided a wireless device. The terminal device includes a processor and a memory, said memory containing instructions executable by said processor, and said processor being configured to cause the terminal device to perform a method as disclosed herein suitable to be implemented in a wireless device.

In a sixth aspect of the disclosure, there is provided a radio network node. The radio network node includes a processor and a memory, said memory containing instructions executable by said processor and said processor being configured to cause the radio network node to perform a method as disclosed herein suitable to be implemented in a radio network node.

According to the various aspects and embodiments as mentioned above performance of LTE-NR Dual Connectivity is increased.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 illustrates an example wireless communication network 100 in which embodiments of the disclosure may be implemented;

FIGS. 2a, 2b and 2c illustrate examples of high level architecture of a wireless communication network in which embodiments of the disclosure may be implemented;

FIG. 3 illustrates a LTE Dual Connectivity User Plane (UP)

FIGS. 4a, 4b and 4c illustrate several different architectural options for realizing LTE-NR dual connectivity;

FIG. 5 illustrates the user plane architecture for LTE-NR tight interworking;

FIG. 6 illustrates split bearer for the control plane in 5G;

FIG. 7 illustrates the LTE-NR tight interworking for the control plane;

FIG. 8 illustrates a signaling flow chart according to some embodiments disclosed herein;

FIG. 9 illustrates a schematic block diagram of an apparatus implemented as/in a wireless device according to an embodiment of the present disclosure;

FIG. 10 illustrates a SCG failure message according to some embodiments as disclosed herein;

FIG. 11 illustrates a schematic block diagram of an apparatus implemented as/in a radio network node according to an embodiment of the present disclosure;

FIG. 12 illustrates a simplified block diagram of an apparatus that may be embodied as/in a network device, and an apparatus that may be embodied as/in a terminal device.

### DETAILED DESCRIPTION

Hereinafter, the principle and spirit of the present disclosure will be described with reference to illustrative embodiments. It should be understood, all these embodiments are given merely for one skilled in the art to better understand and further practice the present disclosure, but not for limiting the scope of the present disclosure. For example, features illustrated or described as part of one embodiment may be used with another embodiment to yield still a further embodiment. In the interest of clarity, not all features of an actual implementation are described in this specification.

References in the specification to “one embodiment,” “an embodiment,” “an example embodiment,” etc. indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or ” includes any and all combinations of one or more of the associated listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

As used herein, the term “wireless communication network” refers to a network following any suitable wireless communication standards, such as NR, LTE-Advanced (LTE-A), LTE, Wideband Code Division Multiple Access (WCDMA), High-Speed Packet Access (HSPA), CDMA2000, and so on. Furthermore, the communications between network devices, and, between a network device and a terminal device in the wireless communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, the NR communication protocols, and/or any other protocols either currently known or to be developed in the future.

As used herein, the term “network device” refers to a device in a wireless communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a NR BS or a gNB), a Remote Radio Unit (RRU), a radio header (RH), a remote radio head (RRH), a relay, a low power node such as a femto, a pico, and so forth, depending on the applied terminology and technology.

The term “terminal device” and “wireless device” are used interchangeably and refers to any end device that can access a wireless communication network and receive services therefrom. By way of example and not limitation, a terminal device may be referred to as user equipment (UE), a Subscriber Station (SS), a Portable Subscriber Station, a Mobile Station (MS), or an Access Terminal (AT). The terminal device may include, but not limited to, a mobile phone, a cellular phone, a smart phone, a tablet, a wearable device, a personal digital assistant (PDA), portable computers, image capture terminal devices such as digital cameras, gaming terminal devices, music storage and playback appliances, wearable terminal devices, vehicle-mounted wireless terminal devices and the like. In the following description, the terms “terminal device”, “terminal”, “user equipment” and “UE” may be used interchangeably.

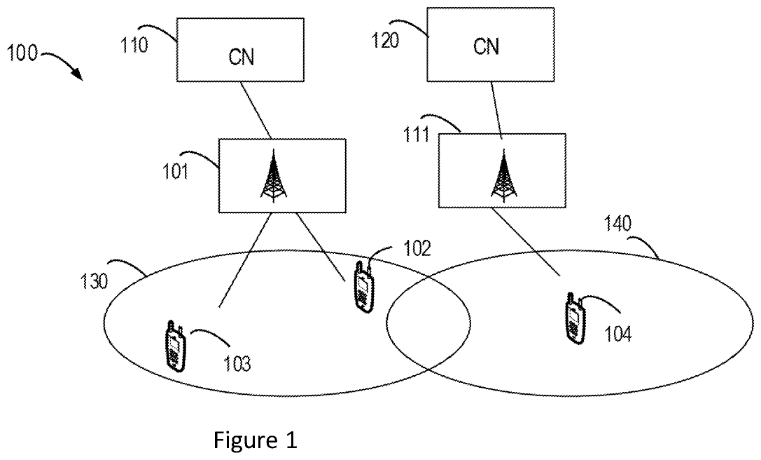

FIG. 1 illustrates an example wireless communication network 100 in which embodiments of the disclosure may be implemented. As shown in FIG. 1, the wireless communication network 100 may include one or more network devices, for example network devices 101 and 111, which may be in a form of an eNB or gNB. It will be appreciated that the network device 101 or 111 could also be in a form of a Node B, Base Transceiver Station (BTS), and/or Base Station Subsystem (BSS), AP and the like, and the network device 101 and 111 may be in different forms. The network device 101 may provide radio connectivity to a set of terminal devices (for example UEs 102 and 103) within a cell 130, while the network device 111 may provide radio connectivity to another set of terminal devices for example UE 104 in another cell 140 shown in FIG. 1. A downlink (DL) transmission herein refers to a transmission from the network device to a terminal device, and an uplink (UL) transmission refers to a transmission in an opposite direction. As shown in FIG. 1, the network devices 101 and 111 connect to a core network (CN) 110 and a CN 120, respectively. For example, the network device 101 may be a 5G gNB connected to a 5G CN 110, and the network device 111 may be a LTE eNB connected to a 4G evolved packet core (EPC) 120. It has been agreed in 3GPP that LTE eNBs should also connect to the 5G-CN in order to provide 5G services for UEs connected to LTE. That is, the network device 111 may also connect to a 5G CN 110. In a deployment, the network device 101 and the network device may connect to a same CN.

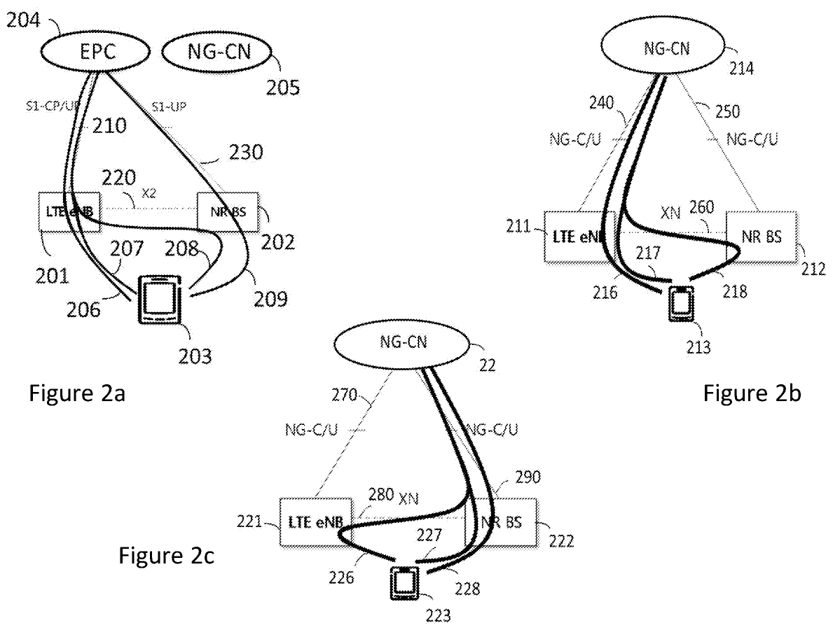

Examples of some high level architecture for connecting a RAN network device such as an eNB or a NR NB (also referred to as gNB) to a CN such as an EPC or an NG/5G CN are illustrated in FIGS. 2A-2C. In FIG. 2A, an LTE eNB 201 connects in CP and UP to an EPC 204 via a S1-CP/UP interface 210. The NR BS 202 connects to the EPC 201 via a S1-UP interface 230, and may connect to the LTE eNB 201 via an X2 interface 220. UE 203 may connect in CP via link 206 to the EPC 204, and connect in UP via one or more of link 207, 208 and 209 to the EPC. In FIG. 2B, an LTE eNB 211 connects in CP and UP to an NG-CN 214 via a NG-C/U interface 240. The NR BS 212 connects to the NG-CN 214 via a NG-C/U interface 250, and may connects to the LTE eNB 211 via an XN interface 260. UE 213 may connect in CP via link 216 to the NG-CN 214, and connect in UP via one or more of link 217 and 218 to the NG-CN. In FIG. 2C, an LTE eNB 221 connects in CP and UP to an NG-CN 224 via a NG-C/U interface 270. The NR BS 222 connects to the NG-CN 224 via a NG-C/U interface 290, and may connects to the LTE eNB 221 via an XN interface 280. UE 223 may connect in CP via link 228 to the NG-CN 224, and connect in UP via one or more of link 226 and 227 to the NG-CN. The following has been observed by inventors of the present disclosure from the example architectures shown in FIGS. 2A-2C:
An LTE eNB can be connected to both an EPC and a 5G CN in both a Control Plane (CP) and a User Plane (UP). For example, the eNB 201 in FIG. 2A may be connected to the EPC 204 via an S 1-CP/UP interface 210. The eNB 211 may connect to the NG CN 214 via a NG-C/U interface 240. The eNB 221 may connect to the NG CN 224 via a NG-C/U interface 270.
An NR BS can be connected in both CP and UP to a 5G CN, and can also be connected in UP to an EPC. For example, the NR BS 202 is connected to the EPC 204 via an S1-UP interface 230, while the NR BS 212 is connected to the NG CN 214 via an NG-C/U interface 250.
The solution supports Dual Connectivity (DC) where the UE is connected to two BSs at the same time and UP data can be send via both BSs. For example, the UE 203 are connected to both the LTE eNB 201 and the NR BS 202, and UP data may be sent via a link 207 or 208 though the LTE eNB 201 and a link 209 though the NR BS 202.
UE configured with DC may be “anchored” in one master RAT (LTE or NR) responsible for managing CP connections, handling mobility, and controlling initial access etc. For example, the UE 213 in FIG. 2B has a dual connectivity with the LTE eNB 211 and the NR NB 212, and is anchored in the LTE eNB 211, while the UE 223 in FIG. 2C is anchored in the NR BS 222. DC is only applied to UEs in RRC_CONNECTED state. A UE in sleep states (e.g. RRC_IDLE, RRC_INACTIVE) is mainly connected to a master RAT.
Since an LTE eNB supports CP connections to both an EPC and a 5G CN, it can act as a master network device for UEs attached to the EPC or the 5G-CN.
Which CN a UE should attach to is usually determined at initial power on of the UE. UEs powering on in a NR cell can only attach to a 5G-CN, while UEs powering on in a LTE cell may choose whether to attach to an EPC or a 5G-CN. It is proposed by inventor of the present disclosure that an LTE eNB may broadcast its capability for supporting the 5G-CN to UEs and the UE choosing to attach to the 5G-CN may indicate its choice in an initial signaling message to the LTE eNB, so that the LTE eNB can route the signaling message to the 5G-CN.

Typically, a UE may stay in a same CN as long as there is coverage of the CN. If a network is not fully covered by the 5G-CN, there may be a need for a UE to transit from one CN to another in some cases, two examples of which are listed below:
the UE is connected to a 5G CN but enters an area where only an EPC is supported;
the UE is connected to an EPC but wants to switch to an NR radio (not using DC), and as a result, the UE has to be moved to a 5G CN.

Depending of state of the UE, procedures for supporting mobility of the UE may vary. Inventors of the present disclosure have envisaged the following possible states for UEs connected to NR or LTE and the 5G-CN:
RRC_CONNECTED: A UE in RRC_CONNECTED state has a RRC connection to a RAN and a corresponding S1 connection to a CN. Context (such as identity, location, bearer, data rate, configurations on encryption, and QoS, etc.) of the UE is available in both the CN and the RAN. Mobility of the UE is controlled by the network (NW), and the UE can transmit/receive user data to/from NW.
RRC_INACTIVE: a UE in a RRC_INACTIVE state does not have a RRC connection to the RAN, but a corresponding S1 connection from the UE to a CN remains. In addition, context of the UE is available in both the CN and the RAN. Mobility of the UE is controlled by the UE itself. The UE may update its location to the RAN/CN with a granularity of tracking area. In the RRC_INACTIVE state, the UE may not send/receive user data to/from NW directly.
RRC_IDLE: a UE in a RRC —IDLE state does not have a RRC connection to the RAN, and does not maintains a corresponding S1 connection to a CN. Context of the UE is only available in the CN. Mobility of the UE is controlled by the UE itself, and the RAN is unaware of a location of the UE. The CN knows a position of the UE in a granularity of a tracking area. In the RRC_IDLE state, the UE cannot send/receive user data to/from the NW directly.

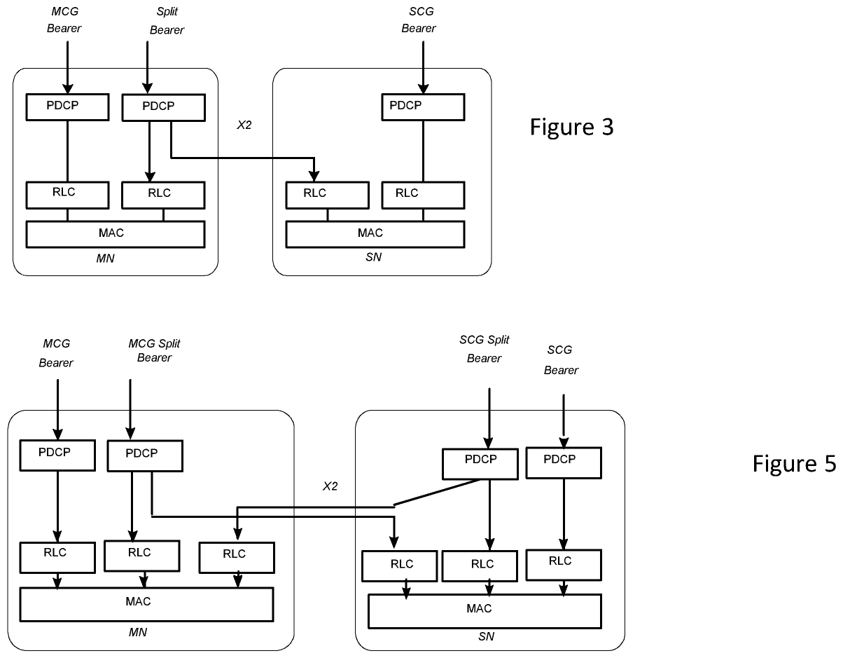

LTE DC: FIG. 3 illustrates a LTE Dual Connectivity User Plane (UP). E-UTRAN supports Dual Connectivity (DC) operation whereby a multiple Rx/Tx UE in RRC_CONNECTED is configured to utilize radio resources provided by two distinct schedulers, located in two eNBs (radio base stations) connected via a non-ideal backhaul over the X2 interface (see 3GPP 36.300). “Non-ideal backhaul” implies that the transport of messages over the X2 interface between the nodes may be subject to both packet delays and losses.

eNBs involved in DC for a certain UE may assume two different roles: an eNB may either act as an MN (Master node), also referred to as Master eNB (MeNB) or as an SN (Secondary node), also referred to as Secondary eNB.(SeNB). In DC a UE is connected to one MN and one SN. Thus, an eNB can act both as an MN and an SN at the same time, for different UEs.

In LTE DC, the radio protocol architecture that a particular bearer uses depends on how the bearer is setup. Three bearer types exist: MCG (Master Cell Group) bearer, SCG (Secondary Cell Group) bearer and split bearers. In the LTE DC infrastructure, RRC is located in the MN and SRBs (Signaling Radio Bearers) are always configured as MCG bearer type and therefore only use the radio resources of the MN. When a node acts as an SN, the LTE DC solution does not have any UE RRC context of that UE and all such signaling is handled by the MN.

In the LTE UE (User Equipment), the corresponding structure exists, wherein the UE is capable and built to send and receive RRC messages over SRBs towards the MN, whereas data traffic over DRBs (Data Radio Bearers) can be carried either over the radio resources allocated to/from the MN or the SN.

NR Dual Connectivity and LTE-NR Tight Interworking:

In 3GPP, a study item on a new radio interface for 5G has recently been completed and 3GPP has now continued with the effort to standardize this new radio interface, often abbreviated by NR (New Radio). LTE-NR DC (also referred to as LTE-NR tight interworking) is currently being defined for Release 15 of the 3GPP specifications.

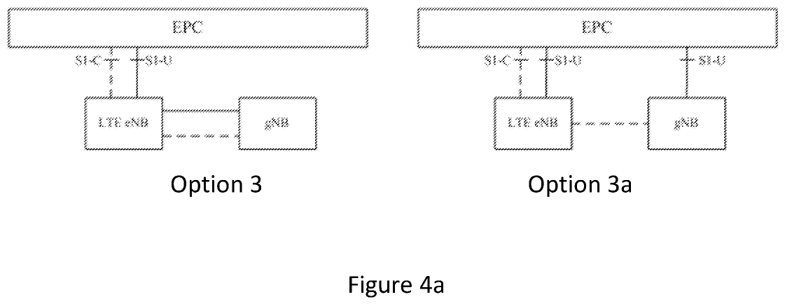

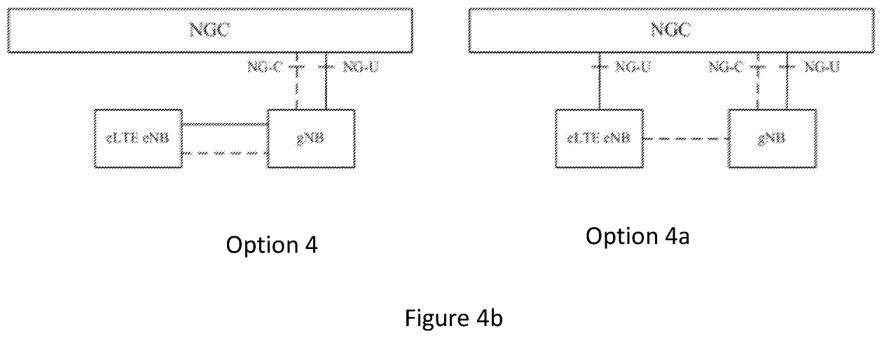

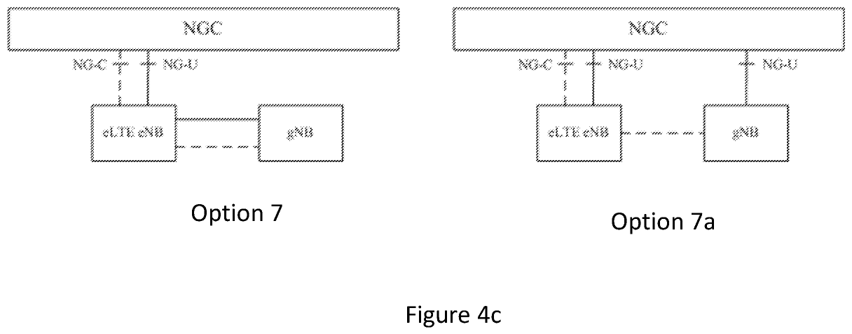

There are several architectural options for realizing LTE-NR dual connectivity, as captured in 3GPP TR 38.801, namely options 3, 4 and 7, which are illustrated in FIGS. 4a, 4b and 4c.

In Option 3/3A, as illustrated in FIG. 4a, the LTE eNB is connected to the EPC with Non-standalone NR. The NR user plane connection to the EPC goes via the LTE eNB (Option 3) or directly (Option 3A).

In Option 4/4A, as is illustrated in FIG. 4b, the gNB is connected to the NGC (Next Generation Core) with Non-standalone E-UTRA. The E-UTRA user plane connection to the NGC goes via the gNB (Option 4) or directly (Option 4A).

In Option 7/7A, as is illustrated in FIG. 4c, the eLTE eNB is connected to the NGC with Non-standalone NR. The NR user plane connection to the NGC goes via the eLTE eNB (Option 7) or directly (Option 7A).

The reader is referred to TS 38.801 (Sections 7 and 10) for the details of the different options. Option 3 has been been prioritized in 3GPP, where the MN is an LTE node while the SN is running NR. However, the methods disclosed herein can be applicable to the other LTE-NR interworking cases as well (e.g. option 4 where the NR node is the master node and LTE is the SN).

Some major changes that has been agreed in 3GPP so far regarding LTE-NR interworking, compared to the LTE DC described above, are:
The introduction of split bearer from the SN (known as SCG split bearer). The SN in this particular case is also referred to as SgNB (secondary gNB, where gNB denotes the NR base station)
The introduction of split bearer for RRC (known as split SRB)
The introduction of a direct RRC from the SN (known as SCG SRB or direct SRB)

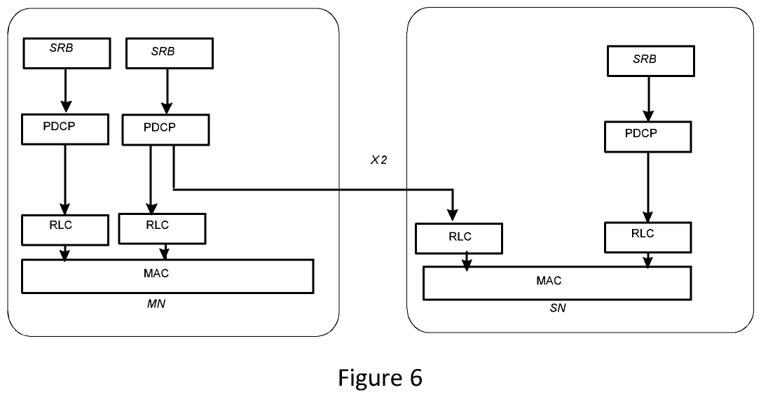

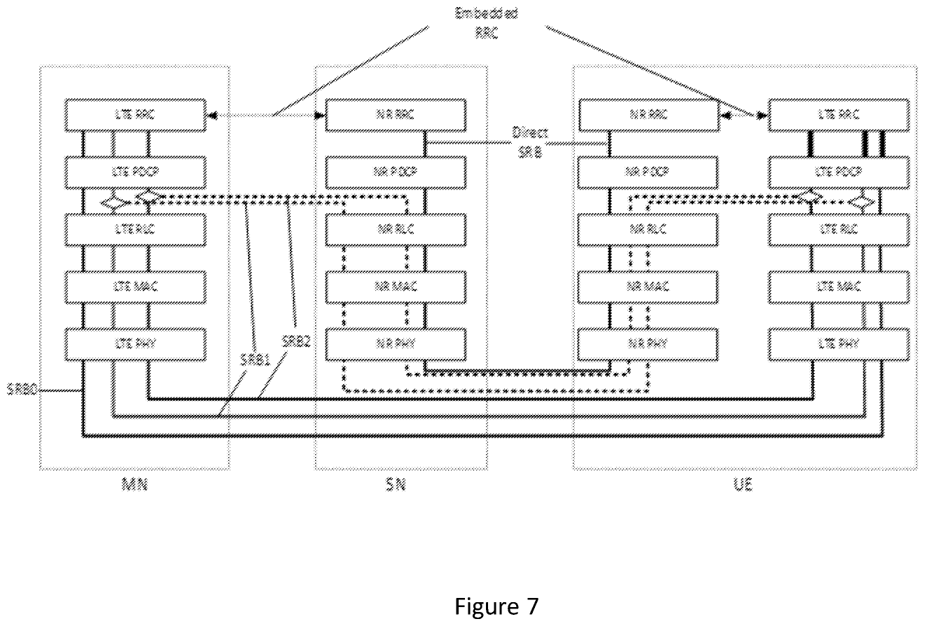

FIG. 5 illustrates the user plane architecture for LTE-NR tight interworking. FIG. 6 illustrates split bearer for the control plane in 5G and FIG. 7 illustrates the LTE-NR tight interworking for the control plane.

In present disclosure, we are referring to the interface between the MN and SN as X2, based on the current interface definitions in LTE. For LTE-NR interworking and NR-NR interworking cases, the exact name for such an interface could end up being different (e.g. Xn instead of X2, with the corresponding XnAP protocol instead of X2AP). However, that will not impact the applicability of the embodiments as disclosed herein.

From FIGS. 6 and 7 it can be seen that separate Signaling Radio Bearers (SRBs) are supported both from the MN and SN. This means that a UE can receive signaling messages, i.e. RRC messages (Radio Resource Control messages) both from the MN and the SN. There will thus be two RRC instances responsible for controlling the UE—one directed from the MN and another from the SN in the depicted scenario.

The consequence of this architecture is that the UE needs to terminate RRC signaling from two instances: both from the MN and the SN. The motivation for introducing such multiple RRC instances in NR DC, and in particular for LTE-NR DC, is that the MN and SN will partly be autonomously responsible for the control of radio resources. For example, the MN is allocating resources from some spectrum using LTE, while the SN will be responsible for configuring and allocating resources from some other spectrum that uses NR. As challenges for allocating resources in LTE and NR may differ substantially (e.g. since NR might be allocated in a spectrum where beam-forming is highly desirable, while LTE might be allocated in a spectrum with good coverage but with very congested resources), it is important that the SN has some level of autonomy to configure and manage the UE on resources associated with the SN. On the other hand, the overall responsibility for connectivity to the UE will likely be at MN node, so the MN node has the overall responsibility e.g. for mobility, state changes of the UE, for meeting quality of service demands of the UE, etc.

The MN and SN may be nodes that use LTE (4G) or NR (5G) radio access technologies. They may both support the same technology, or they may support different technologies.

In the current work in 3GPP, the first step is to support the scenario where the MN uses LTE, connected to the Evolved Packet Core (EPC) and the SN uses NR. In this first step, the NR node (SN in this scenario) is not connected directly to the core-network, but all traffic to and from the UE is carried via the MN from/to the EPC. This scenario is also known as non-stand-alone NR. After the completion of this alternative, 3GPP will then likely continue with standardization efforts that encompass other scenarios, such as when the NR node (also called gNB, i.e. a base-station supporting NR radio) is connected to the Next Generation Core and acts as an MN. The dual connectivity for NR includes many scenarios, such as:
1. The MN supports LTE and SN supports NR discussed above (also called NR “non-stand-alone”);
2. The MN supports NR and the SN supports LTE;
3. Both MN and SN are NR.

A forth scenario is the current LTE DC solution of Figure 3. The embodiments as disclosed herein are not limited to a particular scenario above, and various embodiments will be applicable to several of the scenarios above, also FIG. 3, if the existing LTE DC solution is enhanced with the embodiments described below.

It should be appreciated that the present disclosure is applicable to different scenarios where the MN and SN nodes can apply various radio interface technologies. The MN node can apply e.g. LTE or NR, and the SN node can also use either LTE or NR without departing from the main concept of this invention. Other technologies could also be used over the radio interface. The 3GPP technical report TR 38.304 includes various scenarios and combinations where the MN and SN are applying either NR, LTE or both.

In the scenarios, the UE is connected to multiple base-stations (MN, SN), and wherein the MN and SN each have a level of autonomy for configuring and controlling the UE with regards to its radio resources, reflected e.g. by the support of multiple RRC instances. This controlling and configuring can take place using a signaling protocol using RRC, or alternatively, the controlling and configuring could be implemented using e. g. a MAC (Medium Access Control) protocol.

For the first phase of 5G standardization and 5G deployment, the most likely scenario is that MN will apply LTE, and the SN will apply the new radio interface, NR, currently being under standardization. This scenario is also referred to as EN-DC. Thus, we focus on this scenario and use the term MeNB for the MN, and SgNB for the SN interchangeably, for the rest of this disclosure.

In the description as follows, we describe the solution where the MN node uses LTE and SN uses NR. This should not be seen as any limitation, but just one of the exemplary scenarios where the invention can be applied, see FIG. 4.

In FIGS. 6 and 7, the protocols of the MeNB (leftmost) and SgNB (second from left) both terminate the RRC protocols of LTE and NR, respectively. As can be seen, the UE (to the right) therefore terminates both an LTE RRC and an NR RRC protocol instance.

A control signaling mechanism (in addition to direct SRB and split SRBs) in LTE-NR tight interworking is using embedded RRC also illustrated in FIG. 7. Embedded RRC is employed when direct SRB is not available and the SgNB has to configure the UE that affects only the NR leg

The SgNB then sends the RRC message to the MeNB via the X2 interface, which the MeNB then embeds in its own RRC message and sends via SRB1 (which could be split SRB or MCG SRB). The UE will then be able to extract the embedded NR RRC message from the container MeNB RRC message and apply the configurations on the NR leg. In the UL direction, the UE embeds the NR RRC messages in an LTE RRC message towards the MeNB, and the MeNB will extract the embedded NR RRC message from this and forwards it to the SgNB.

SCG Failure

The LTE technology and related specifications include procedures for SCG failure (Secondary Cell Group failure). The term “Group” is used, since the MN and the SN can use Carrier Aggregation to configure multiple cells for both SN and the MN. SCG failure can be triggered for a number of reasons, e.g. when the UE fails to maintain a connection to the SN (i.e. a connection via the cells of the SN) in which case the UE monitors the link quality to the PSCell (Primary Secondary Cell) of the SCG. Alternatively, an SCG failure can be triggered by a failure during the change of SCG. The procedures for initiating and executing SCG failure according to the LTE technology is described in TS 36.331 clause 5.6.13.

The purpose of the SCG failure procedure is to notify the network that the connection to the SN is malfunctioning or broken. This is achieved by sending an SCGFailurelnformation message to provide SCG radio link failure information to the MN, after which the MN can try e.g. to recover or re-establish a new SCG via the previous SN, or through a different SN. For example, the MN may need to assign a new PSCell.

The SCGFailurelnformation is an LTE RRC message that contains various pieces of information of relevance for controlling the connection to the UE, including measurement information as configured by the MN node. The message also includes a cause flag carrying information about the reason for the triggering of the information. See clause 5.6.13.3 of TS 36.331 for additional information.

For NR, 3GPP has agreed to also use SCG failure procedures for recovering from SCG failure. However, there is yet no details specified for this procedure. In addition, the LTE solution is not easily adapted to the DC solutions anticipated for 5G (NR), as will be explained below.

Inventors of the present disclosure have envisaged that it will be beneficial to provide a solution to the problem of information encoding and message transmission at Secondary Cell Group failure where a UE is configured to measure radio characteristics for different radio technologies.

Till now, no solution has been proposed to facilitate the availability of measurement reports from a SCG failure to the SN or to another node.

In order to solve at least part of the above problems, methods, apparatuses and computer programs have been proposed herein.

In its work on addressing SCG failure, 3GPP work-group meeting 2 (RAN2) has agreed according to the following for LTE-NR DC (LTE and NR Dual Connectivity):

R2-1704001: Report of 3GPP TSG RAN WG2 meeting #97bis Spokane, USA 3-7 April, 2017 (available at http://www.3gpp.org/ftp/tsg_ran/WG2_RL2/TSGR2_97bis/Report/R2-1704001.zip)

### Agreements:

1: In LTE-NR DC, following SgNB failure cases need to be supported:
   SgNB RLF;
   SgNB change failure;
   exceeding the maximum uplink transmission timing difference (if EN-DC supports the synchronised operation case which is RAN1 decision);
   SgNB configuration failure (only for message on SCG SRB);
   SgNB RRC integrity check failure;
2: In LTE-NR DC, the UE shall report the SCGFailurelnformation to the MeNB instead of triggering the reestablishment upon SgNB failure.
3: Upon SgNB failures, UE shall:
   Suspend all SCG DRBs and suspend SCG transmission for MCG split DRBs, and SCG split DRBs;
   Suspend direct SCG SRB and SCG transmission for MCG split SRB;
   Reset SCG-MAC;
   send the SCGFailurelnformation message to the MeNB with corresponding cause values.

As can be seen, there are multiple criteria for triggering an SgNB failure under bullet 1 that needs to be catered for. In response, the UE shall send a SCGFailurelnformation to the MeNB (bullet 2) and suspend transmissions to, and receptions from the SgNB (bullet 3). The message will include information about the cause of the triggering.

While the current agreements seem to be pretty much similar to the LTE solution describe before, it turns out that the LTE solution for SCG failure and recovery cannot be applied directly to LTE-NR DC. The inventors have realized that there are factors in to LTE-NR DC that would make the LTE SCG failure procedures suboptimal if not malfunctioning, if applied as such.

One of the particularities of the new LTE-NR DC solution is that both the MeNB and the SgNB have added autonomy to control the radio resources within LTE and NR, respectively. This is reflected by the fact that both the MeNB and the SgNB have their own RRC protocols, and the UE needs to terminate both the LTE RRC protocol and the NR RRC protocol.

For example, the MeNB may configure the UE to perform certain cell measurements for handover or cell addition to carrier aggregation, or for example for the change of SgNB, or for the release of SgNB, etc. Those configurations will follow the configuration sent to the UE using the LTE RRC protocol.

In addition, the SgNB has its own RRC protocol, wherein this NR RRC protocol can be used for configuring e.g. NR measurements for beam management or mobility within cells under the control of the SgNB. Those measurements are intended for the SgNB and would not necessarily be comprehended by the MeNB, as they will be encoded by the syntax of the protocols of the NR radio interface. The measurements could be provided on the RRC level, or e.g. on the MAC or Physical layer.

Thus, if the LTE solution was to be applied, at an SCG failure, the UE would report its measurements to the MeNB in the SCG failure message. However, the UE can only report the measurements of configured by the MeNB to the MeNB, as the MeNB will only know about the measurement configurations that it has established itself, and it will not expect any measurement reports configured by the SgNB. Applying the LTE solution would therefore be suboptimal, because the reasons for the failure towards the SgNB might not be visible in measurements configured by the MeNB.

The inventors have also realized that the measurements provided according to the UE NR RRC protocol, as configured by the SgNB, may be of significant benefit when recovering after the SCG failure, and when further tuning the network parameters and radio resource management procedures to eliminate or reduce the number of future SCG failures. This is because the radio problem that caused the SCG failure at the SgNB should best be visible in measurements within the radio of the SCG.

The SgNB has its own RRC protocol, wherein this NR RRC protocol can be used for configuring e.g. NR measurements for beam management or mobility within or between cells under the control of the SgNB. Those measurements are intended for the SgNB and would not necessarily be comprehended by, or useful for the MeNB, as they will be encoded by the syntax of the protocols of the NR radio interface.

According to one embodiment a UE is connected with Dual Connectivity to two radio-base-stations, wherein the UE is configured by two separate control entities (RRC termination points) to perform measurements for radio resource management. Separate measurements reports may be sent to the MN and SN, respectively. In one embodiment MN uses LTE, and SN uses NR.

The UE now undergoes a failure towards the SN (SCG failure). There can be different causes for the failure, such as detected bad radio connectivity to the PSCell of the SN.

Triggered by the SN failure, and through the recovery procedure, the UE now informs the MN of the SCG failure with an SCG failure message. The message is sent to the MN.

The SCG failure message comprises measurement information, wherein the measurement information comprises measurement information configured both by the MN RRC and the SN RRC.

The measurements information associated with the SN RRC is encoded according to the syntax of the SN RRC protocol. The encoded information is encapsulated in the SCG failure message, wherein the SCG failure message carriers the encapsulated information as an octet string. The SCG failure message is encoded according to the syntax of the MN RRC protocol.

The MN receives the SCG failure message. The MN node decodes the message and identifies the octet string comprising the measurement information encoded according to the SN RRC protocol. The MN forwards the octet string over an interface towards an gNB, such as the current SgNB where the failure occurred, or to another SgNB, such as a second SgNB that the MN selects for re-establishing or establishing a new NR connection towards the UE. The MN could also additionally forward the measurements that are encoded according to the syntax of the MN RRC which were also part of the SCG failure information.

In one embodiment a UE is configured with dual connectivity (DC). In DC, the UE is connected to one MN and one SN. The UE may be configured with Carrier Aggregation to both the MN and the SN, i.e. there can be multiple cells (i.e. component carriers in the uplink and downlink) that the UE and both the MN and SN are using for sending data and signaling between the MN/SN and the UE. In a simple scenario, the MN and UE is communicating over one cell, and the SN and the UE communicates over another cell. The UE has a Primary Cell (PCell) among the associated with the cells of the MN, and a PSCell (Primary Secondary Cell) among the cells associated with the SN. Thus, at minimum, the UE has one PCell and one PSCell, with possible additional secondary cells towards the MN and SN, respectively.

A cell may comprise both an UL and a DL component carrier. A minimum is that the UE is configured with at least one uplink (UL) and one downlink (DL) component carrier amongst its cells. The UE may also be configured with multiple UL and DL component carriers associated with multiple cells.

In the present disclosure, the UE is connected using Dual Connectivity to two radio-base-stations, wherein the UE is configured by two separate control entities (RRC termination points) to perform measurements for radio resource management. Separate measurements reports may be sent to the MN and SN, respectively. The purpose of such measurements is to e.g. enable good radio resource management decisions in the MN and SN, respectively. Actions related to such radio resource management include cell handovers (PCell change), beam management, establishment and release of connections, additions and removals of secondary cells, change of SN or SCG, etc. Both the MN and SN can perform such RRM decisions, partly independent of each other. For example, the SN may decide on beam management within the resources that it controls, while the MN may decide about SCG change, PCell handover, etc.

In one embodiment MN uses LTE, and SN uses NR. In such a case, the MN is also referred to as the MeNB, and the SN is referred to as SgNB. However, without any limitation of the applicability of the present invention, the MN and SN may also apply other technologies, or such that e.g. the MN applies NR and the SN LTE.. In this preferred embodiment, the UE thus terminates LTE RRC towards the MN and NR RRC towards the SN.

Typically, the LTE RRC measurements may relate to cell-level measurements that are needed by the MN to perform its Radio Resource Management, such as mobility, cell or component carrier addition/removal in carrier aggregation, or SCG change/addition/removal, or MN handover (PCell change or handover, which may or may not imply a change of MN node.)

In addition, the UE may be configured with NR RRC measurements configured by the SN. Such measurements could be configured e.g. to perform beam management in NR.

Measurement reports based on LTE RRC measurements may include e.g. cell identification information and signal strength and/or signal quality information associated with the identified cell. At least, the LTE RRC measurements may comprise current measurements provided by the current LTE RRC protocol, wherein the measurements configured with the LTE RRC protocol may include necessary measurement for measuring on NR measurement objects, such as frequencies configured for using the NR protocol. Such objects may include objects (frequencies) where the SN (SgNB) has cells.

Measurement reports based on NR RRC measurements may include e.g. cell identification information, such as the ones known from LTE RRC described above, and it may include e.g. beam identification information, including signal strength and/or signal quality information associated with the identified cell.

The UE now performs measurements both according to the configuration received from the MN node based on the LTE RRC protocol and based on the configuration received from the SN node based on the NR RRC protocol.

The UE may perform measurements on an NR measurement object. The NR measurement object may be subject to measurements based on both the LTE measurement configuration and the NR measurement configuration. Thus, the UE performs NR measurement based on two configurations. The configurations for NR object measurements may be different, in that the measurement configuration received from the MN is different compared to the measurement configuration received from the SN. For example, the configuration received from the MN may ask the UE to perform measurements on a cell-level, while the measurement configuration received from the SN may ask the UE to perform measurement on a beam level.

The UE now undergoes a failure towards the SN (SCG failure). There can be different causes for the failure, such as detected bad radio connectivity to the PSCell towards the SN, often identified via the Radio Link Failure procedures. The failure may also be caused by an SN (SgNB) change failure, or other causes leading to unreliable or non-existent possibilities to maintain communication, such as data transfer, between the SN and the UE.

Triggered by the SN failure, and through the recovery procedure, the UE now informs the MN of the SCG failure with an SCG failure message. The message is sent to the MN.

In one embodiment, the UE continues to measure according to both RRC measurement configurations after the failure. Alternatively, the UE stores measurement information that it had acquired before the failure.

In one embodiment, the UE now sends measurement information to the MN according to either one or both the MN RRC configuration and the SN RRC configuration.

Such measurement information may be related to specific measurement objects. Such an object is e.g. a measurement frequency on which cells are configured. An object may be associated with an identity. In some cases, the MN and SN may configure different objects. In some cases, the MN and SN may configure the same objects. In a particular embodiment, the same object (i.e. cells on a frequency) may be referred to with different object identities in the LTE measurement configuration and in the NR configuration.

Measurement information may also use different quantities in LTE and NR. For example, beam management related measurements may be encoded differently from cell-level measurements, the qualtities (such as pilot strength, quality, rank, etc) may be different, and the different measurements of LTE and NR may be based on different pilot signals or reference symbols, even in the case that the object (e.g. an NR carrier frequency) is the same.

The UE may perform both cell and beam-level measurements, wherein the cell and beam level measurements may be performed on e.g. Synchronization Signals (SS) or reference signals for Channel State Information (CSI-RS), depending on which measurements have been configured.

In particular, it is anticipated that NR includes various beam related measurements and reports, in addition to more conventional cell-level measurements and reports.

Thus, the UE may perform such measurements and send such reports, if configured by the NR RRC from the SN.

The UE may perform Radio Link Monitoring based on a configured Reference Signal (RS). For example, if the UE detects a failure on a beam failure, the UE may try to select another downlink beam from the SgNB (SN).

If the UE fails to select a good beam associated with the SgNB, it may consider that the connection to the SCG at the SN has failed. For example, the UE may be configured to try a pre-determined or configurable number of times to select a better beam, but if the UE continues to fail to re-establish a good connection to the SCG, it may consider that an SCG failure has occurred.

For example, the UE may try to reconnect to the SCG via another beam that it selects using Random Access attempts, but if the UE receives no response, or if the RA procedure is unsuccessful one or several times, it may consider that an SCG failure has occurred. On the other hand, if the RA is successful, the UE may continue being connected in DC to both the MN and the SN.

In a preferred embodiment, the UE encodes the measurement information associated with the LTE RRC configuration using the syntax of the LTE RRC protocol and the measurement information associated with the NR RRC configuration using the syntax of the NR RRC protocol specification. Typically, the RRC messages would semantically be encoded according to the ASN.1 syntax.

The UE sends either one or both the measurement information associated with the LTE RRC and NR RRC configuration in the same SCG failure message. The message is sent to the MN. The message is encoded by the UE such that the measurement information associated with the NR RRC configuration is encapsulated in the LTE RRC message. The UE encapsulates the NR RRC information as an octet string into an LTE RRC message. In one embodiment, the encapsulated octet string is a message defined by the NR RRC protocol. In another embodiment, the octet string is an RRC message, an Information Element or a Field defined in the NR RRC protocol.

In particular, the measurement information related to the SN measurement configuration may include e.g. any of information about the number of recovery attempts after beam failure, beam identity or identities where the recovery was attempted, and beam identity where the failure occurred. Such information may be provided in addition to actual measurement results related to e. g. signal or pilot signal strength of e. g. SS or CSI-SS, or signal quality of such pilots.

All the SN measurements (i.e. both cell level and beam level) are included in one IE in the SCGFailureInformation message or a separate IE is used for cell level and beam level measurements. In both cases, the measurements can be encoded as an OCTET string in the MN specification (i. e. MN doesn 't have to know how to interpret the message in the IE (s)).

Here, it should again be appreciated that the notation of “LTE RRC” or “NR RRC” are exemplary, and different RRC instances for MN and SN will apply for other architectures, as already described.

The LTE RRC message can be an SCG failure message. The message is specified in the future version of TS 36.331, while the octet string representing the measurement information associated with the NR RRC is encoded according to a future version of TS 38.331.

The disclosure also includes embodiments in the infrastructure. The inventors realize that the measurement information received in the SCG failure message is advantageous for both PSCell change, for beam management, and for Self Organizing Networks (SON).

When the MN receives the SCG failure message, it decodes the message based on the syntax of the LTE RRC protocol. Based on the information decoded by the MN, the MN may decide to change e.g. the PSCell in the SCG of the MN, or it may decide to change SCG altogether, potentially to an SCG controlled by a different SN.

The MN identifies the encapsulated octet string that carries information related to the NR RRC measurement configuration. The MN then forwards the octet string over an interface in the LTE/NR infrastructure towards an SN. The SN may e. g. be the SN that was controlling the SCG (and the PSCell) where the SCG failure occurred. Alternatively, the SN may be a different gNB selected by the MN for acting as an SN for the UE.

If the decision by the MN was to change the SN, then the MN can forward the measurements included in the SCGfailurelnformation report to the old SN (i.e. the SN was serving the SCG cells when the SCG failure was detected) by including them in and enhanced version of the SN release message (e.g. an optional IE for including SN measurement reports, which can be encoded as an OCTET STRING, is added to the LTE-DC SeNB release message). The MN can also include a cause value in the release message indicating that the release was triggered due to SCG failure (different cause values could also be used corresponding to the different reasons of the SCG failure). The MN can also forward the measurement information to the new SN that it has chosen in the SN addition message (e.g. an optional IE including SN measurement reports, which can be encoded as an OCTET STRING, is added to the LTE-DC SeNB Addition Request message). It should be noted that the measurement that is sent to the old and new SNs can be the same or different (e.g. MN may pass only cell level measurements to the old SN, and pass both cell level and beam level measurement to the new SN, if two separate IEs were included in the SCGFailurelnformation for the cell level and beam level measurements).

The old SN can utilize the forwarded measurements in the SN Release message for mobility robustness optimization (MRO). For example, it can adjust the handover/selection offsets/thresholds that it is using (e.g. for selecting PScell, for adding/removing SN SCells, etc) depending on the number of the SN Release messages, as well as the included measurements therein, that it is getting from the MN that indicates a cause value related to SCG failure.

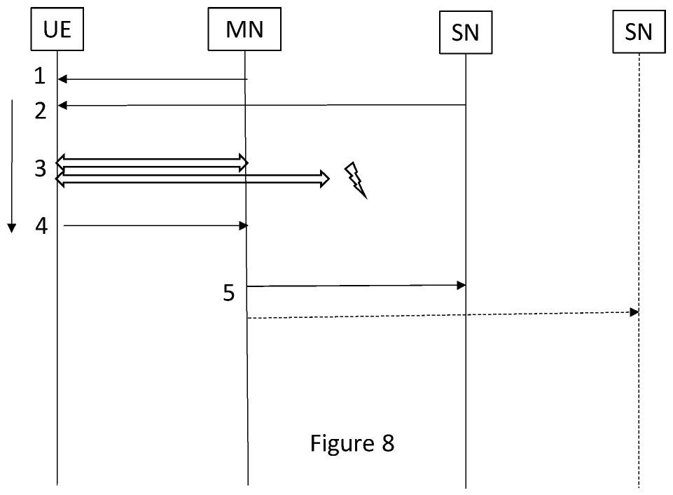

FIG. 8 illustrates a signaling flow chart according to some embodiments disclosed herein.

In signaling message 1 the UE is configured with MN RRC measurements (such as LTE RRC) and in signaling message 2 the UE is configured with SN RRC measurements (such as NR RRC). The vertical arrows 3 illustrates that the UE performs measurements according to the received configurations. Further the UE detects a failure of the SCG, e.g. through an RLF detection on the PSCell. In signaling message 4 the UE sends an SCG failure to the MN according to the present disclosure and the MN forwards the information in the SCG failure message to an SN in signaling message 5, as described herein. The dashed line indicates that the information may be forwarded to the previous SN or to a different node that supports the technology of the SN, e.g. during SN change of the UE.

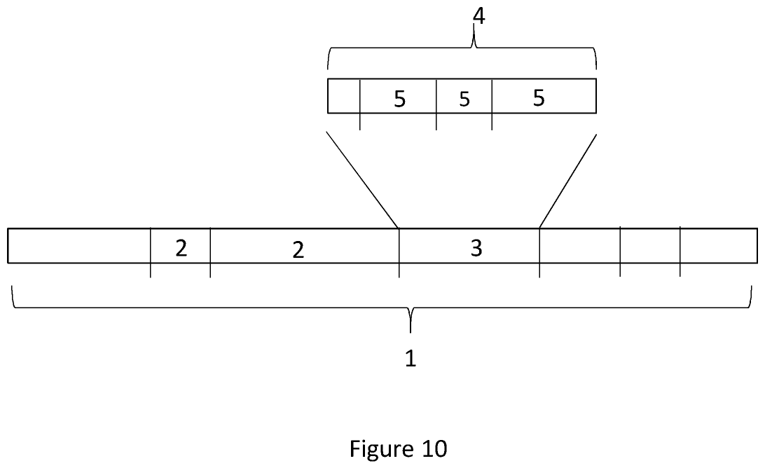

FIG. 10 illustrates a SCG failure message 1 sent from the UE to the MN. The message 1 consists of one or several Information Elements (IEs) denoted 2. The message 1 is encoded using the RRC syntax of the MN RRC protocol.

The message may contain one or several IEs 2 that carry measurement information related to the MN RRC configuration.

The message 1 may further encapsulate a block 3, which comprises an octet string carrying measurement information related to the SN measurement configuration. The block 3 in the message 1 may be an Information Element carried in message 1.

The IE or octet sting 3 may in turn be encoded according to the RRC syntax of the SN RRC protocol. The octet string 3 may thus be interpreted as an RRC message, RRC IE, or RRC field of the SN RRC protocol denoted 4. Thus, element or octet string 3 may therefore carry multiple IEs 5 that carry measurement information related to the measurement configuration of the SN RRC configuration.

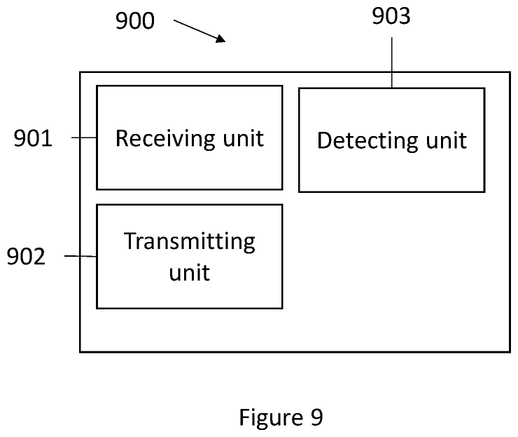

Reference is now made to FIG. 9, which illustrates a schematic block diagram of an apparatus 900 in a wireless communication network (e.g., the wireless communication network 100 shown in FIG. 1). The apparatus may be implemented as/in a wireless device, e.g., the terminal device 102 shown in FIG. 1. For ease of discussions, apparatus 900 will be described below with reference to the environment as described with reference to FIG. 1. The terminal device 102 is in a first cell (e.g., the cell 130 served by the network device 101 shown in FIG. 1) and connected to a first CN 110 (e.g., the 5G CN).

The apparatus 900 is operable to carry out the methods implemented in a wireless device as described herein and possibly any other processes or methods as suitable. It is also to be understood that the methods are not necessarily solely carried out by the apparatus 900. At least some steps of the methods may be performed by one or more other entities.

As illustrated in FIG. 9, the apparatus 900 includes a receiving unit 901, a transmitting unit 902 and a detecting unit 903.

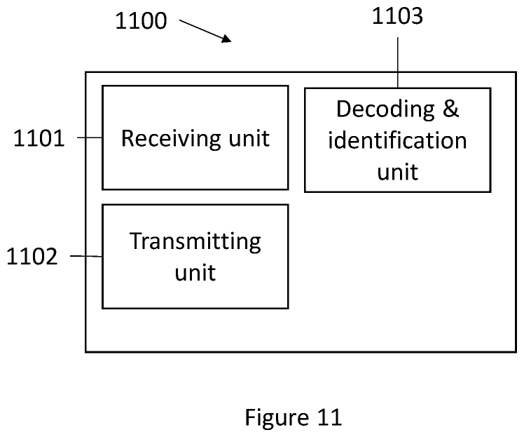

FIG. 11 illustrates a schematic block diagram of an apparatus 1100 in a wireless communication network (e.g., the wireless communication network 100 shown in FIG. 1). The apparatus may be implemented as/in a first network device, e.g., the network device 101 shown in FIG. 1 or any other suitable network device. For ease of discussions, apparatus 1100 will be described below with reference to the environment as described with reference to FIG. 1.

The apparatus 1100 is operable to carry out the methods implemented in a network device as disclosed herein and possibly any other processes or methods. It is also to be understood that the methods are not necessarily solely carried out by the apparatus 1100. At least some steps of the methods can be performed by one or more other entities.

As illustrated in FIG. 11, the apparatus 1100 includes a first receiving unit 1101, a transmitting unit 1102 and a decoding and identification unit 1103.

Furthermore, it would be appreciated that apparatuses 900 & 1100 may comprise other units not shown in FIGS. 9 & 11. In addition, some units or modules in the apparatus 9 & 11 can be combined in an embodiment, or may be omitted in another embodiment.

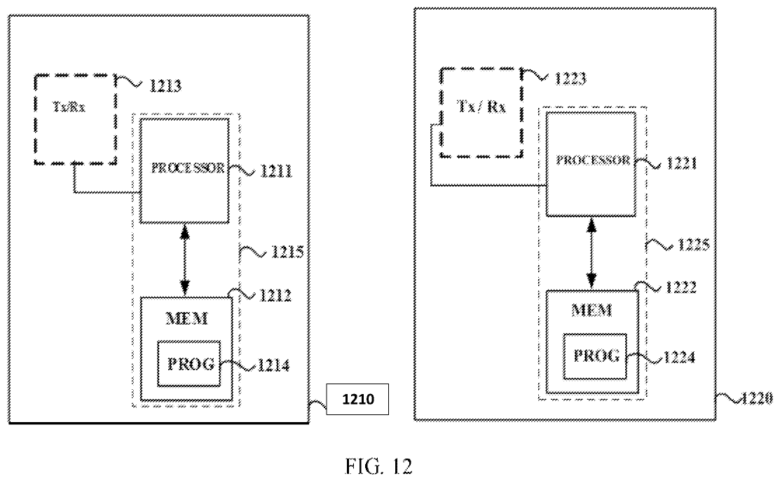

FIG. 12 illustrates a simplified block diagram of an apparatus 1210 that may be embodied in/as a terminal device, e.g., the terminal device 102, 103, or 104 shown in FIG. 1, and an apparatus 1220 that may be embodied in/as a terminal device, e.g., one of the network devices 101 and 111 shown in FIG. 1.

The apparatus 1210 may include one or more processors 1211, such as a data processor (DP) and one or more memories (MEM) 1212 coupled to the processor 1211. The apparatus 1210 may further include a transmitter TX and receiver RX 1213 coupled to the processor 1211. The MEM 1212 may be non-transitory machine readable storage medium and it may store a program (PROG) 1214. The PROG 1214 may include instructions that, when executed on the associated processor 1211, enable the apparatus 1210 to operate in accordance with the embodiments of the present disclosure, for example to perform the method 500. A combination of the one or more processors 1211 and the one or more MEMs 1212 may form processing means 1215 adapted to implement various embodiments of the present disclosure.

The apparatus 1220 includes one or more processors 1221, such as a DP, and one or more MEMs 1222 coupled to the processor 1221. The apparatus 1220 may further include a suitable TX/RX 1223 coupled to the processor 1221. The MEM 1222 may be non-transitory machine readable storage medium and it may store a PROG 1224. The PROG 1224 may include instructions that, when executed on the associated processor 1221, enable the apparatus 1220 to operate in accordance with the embodiments of the present disclosure. A combination of the one or more processors 1221 and the one or more MEMs 1222 may form processing means 1225 adapted to implement various embodiments of the present disclosure.

Various embodiments of the present disclosure may be implemented by computer program executable by one or more of the processors 1211 and 1221, software, firmware, hardware or in a combination thereof.

The MEMs 1212 and 1222 may be of any type suitable to the local technical environment and may be implemented using any suitable data storage technology, such as semiconductor based memory terminal devices, magnetic memory terminal devices and systems, optical memory terminal devices and systems, fixed memory and removable memory, as non-limiting examples.

The processors 1211 and 1221 may be of any type suitable to the local technical environment, and may include one or more of general purpose computers, special purpose computers, microprocessors, digital signal processors DSPs and processors based on multicore processor architecture, as non-limiting examples.

In addition, the present disclosure may also provide a memory containing the computer program as mentioned above, which includes machine-readable media and machine-readable transmission media. The machine-readable media may also be called computer-readable media, and may include machine-readable storage media, for example, magnetic disks, magnetic tape, optical disks, phase change memory, or an electronic memory terminal device like a random access memory (RAM), read only memory (ROM), flash memory devices, CD-ROM, DVD, Blue-ray disc and the like. The machine-readable transmission media may also be called a carrier, and may include, for example, electrical, optical, radio, acoustical or other form of propagated signals—such as carrier waves, infrared signals, and the like.

The techniques described herein may be implemented by various means so that an apparatus implementing one or more functions of a corresponding apparatus described with an embodiment includes not only prior art means, but also means for implementing the one or more functions of the corresponding apparatus described with the embodiment and it may include separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Example embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including hardware, software, firmware, and a combination thereof. For example, in one embodiment, each block of the block diagrams and flowchart illustrations, and combinations of blocks in the block diagrams and flowchart illustrations can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-16. (canceled)

17. A method for handling radio connectivity failure in a wireless device connected to a radio first network node through a first radio connection and to at least a second radio network node through at least a second radio connection using Dual Connectivity, the method comprising:
receiving, from the first network node, a first measurement configuration for measuring radio related characteristics for the first radio connection;
receiving, from the second network node, a second measurement configuration for measuring radio related characteristics for the at least second radio connection;
detecting a radio connectivity failure for the at least one second radio connection; and
transmitting a message to the first radio network node using the first radio connection wherein the message comprises measurement results according to the received measurement configuration for the second radio connection.

18. The method according to claim 17, wherein the first radio network node is an LTE radio network node and the second radio network node is an NR radio network node.

19. The method according to clam 17, wherein:
the wireless device is configured with a first RRC protocol for the first radio connection and a second RRC protocol for the at least second radio connection; and
the first and second RRC protocols are different RRC protocols.

20. The method according to claim 17, wherein the first and second measurement configurations define different measurements.

21. The method according to claim 19, wherein the second RRC protocol implements at least one type of radio measurements which is not implemented by the first RRC protocol.

22. The method according to claim 19, wherein the first RRC protocol is unable to decode at least one radio measurement result obtained through configuration by the second RRC protocol.

23. The method according to claim 17, wherein:
the first radio connection is a primary cell group;
the second radio connection is a secondary cell group;
the first radio network node is a Master Node;
the second radio network node is a Secondary Node; and
the failure report is a Secondary Cell Group failure message.

24. The method according to claim 19, further comprising encoding an SCG failure report according to the specification of the second RRC
protocol, wherein the SCG failure report includes measurement results based on
the received measurement configuration for the second radio connection; and encapsulating the SCG failure report in the message, wherein
the message is encoded according to the first RRC protocol.

25. The method according to claim 24, wherein the encapsulation is achieved using an octet string of data and wherein said message is an SCG failure message encoded according to the first RRC protocol.

26. The method according to claim 17, wherein the message comprises measurement results based on the received measurement configuration for the first radio connection.

27. A method in a radio network node for handling Secondary Cell Group failure, comprising:
transmitting a measurement configuration to a User Equipment;
receiving a SCG failure message from said User Equipment;
decoding the SCG failure message;
identifying an encapsulated message in the SCG failure message; and
transmitting the encapsulated message to a second radio network node.

28. The method according to claim 27, further comprising obtaining an address of the second radio network node from the SCG failure message.

29. A wireless device configurable to handle radio connectivity failure when connected to a radio first network node through a first radio connection and to at least a second radio network node through at least a second radio connection using Dual Connectivity, the wireless device comprising:
a transmitter;
a receiver;
at least one processor operatively coupled to the transmitter and to the receiver; and
at least one memory storing computer-executable instructions that, when executed by the at least one processor, configure the wireless device to:
receive, from the first network node, a first measurement configuration for measuring radio related characteristics for the first radio connection;
receive, from the second network node, a second measurement configuration for measuring radio related characteristics for the at least second radio connection;
detect a radio connectivity failure for the at least one second radio connection; and
transmit a message to the first radio network node using the first radio connection, wherein the message comprises measurement results according to the received measurement configuration for the second radio connection.

30. A radio network node comprising a processor and a memory, wherein said memory comprises instructions that, when executed by said processor, configure the radio network node to perform operations corresponding to the method of claim 27.

31. A non-transitory, computer-readable medium storing computer-executable instruction that, when executed by a processor comprising a wireless device, configure the wireless device to carry out operations corresponding to the method according to claim 17.
